(19) United States
(12) Patent Application Publication
(10) Pub. No.: US 2025/0030663 A1
(43) Pub. Date: Jan. 23, 2025

(54) SECURE SERVICE ACCESS WITH MULTI-CLUSTER NETWORK POLICY

(71) Applicant: VMware, Inc., Palo Alto, CA (US)

(72) Inventors: Yang Ding, Fremont, CA (US); Jiahao Wu, Sunnyvale, CA (US); Jianjun Shen, Redwood City, CA (US); Lan Luo, Beijing (CN); Akshay Katrekar, Mountain View, CA (US); Guna Singh Bagavath Singh Chidambaram Udhaya Singh, Newark, CA (US)

(21) Appl. No.: 18/235,772

(22) Filed: Aug. 18, 2023

(30) Foreign Application Priority Data
Jul. 17, 2023 (WO) PCT/CN2023/107673

(51) Int. Cl. H04L 9/40

(52) U.S. Cl. CPC H04L 63/0227; H04L 63/029

(57) ABSTRACT

Techniques associated with exchanging data between clusters are disclosed. A data packet can be received from a first pod in a first cluster of a cluster set that targets a second pod or service in a second cluster of the cluster set. A label identity is determined for the first pod from a table of pods and label identities. The label identity for the first pod is added in a virtual network identifier field of a data packet header. The data packet is communicated from a first virtual switch to the second cluster through a tunnel interface and gateway node. Upon receipt of the data packet, the label identity is extracted from the data packet header, and an ingress rule associated with the label identity can be determined. Access to the second pod is controlled based on the rule.

### CLAIM OF PRIORITY

This application claims priority to International Application Number PCT/CN2023/107673, entitled “Secure Service Access with Multi-Cluster Network Policy”, filed on Jul. 17, 2023. The disclosure of this application is hereby incorporated by reference.

### BACKGROUND

Software defined networking (SDN) involves a plurality of hosts in communication over a physical network infrastructure of a data center (e.g., an on-premise data center or a cloud data center). The physical network to which the plurality of physical hosts is connected may be referred to as an underlay network. Each host has one or more virtualized endpoints, such as virtual machines (VMs), containers, Docker containers, data compute nodes, isolated user space instances, namespace containers, and/or other virtual computing instances (VCIs), that are connected to, and may communicate over, logical overlay networks. For example, the VMs and/or containers running on the hosts may communicate with each other using an overlay network established by hosts using a tunneling protocol.

A container is a package that relies on virtual isolation to deploy and run applications that access a shared operating system (OS) kernel. Containerized applications, also referred to as containerized workloads, can include a collection of one or more related applications packaged into one or more groups of containers, referred to as pods.

Containerized workloads may run in conjunction with a container orchestration platform that automates much of the operational effort required to run containers with workloads and services. This operational effort includes a wide range of things needed to manage a container's lifecycle, including, but not limited to, provisioning, deployment, scaling (e.g., up and down), networking, and load balancing. Kubernetes® (K8S®) software is an example open-source container orchestration platform that automates the operation of such containerized workloads. A container orchestration platform may manage one or more clusters, such as a K8S cluster, including a set of nodes that run containerized applications.

As part of an SDN, any arbitrary set of VCIs in a data center may be placed in communication across a logical Layer 2 (L2) overlay network by connecting them to a logical switch. A logical switch is an abstraction of a physical switch collectively implemented by a set of virtual switches on each node (e.g., host machine or VM) with a VCI connected to the logical switch. The virtual switch on each node operates as a managed edge switch implemented in software by a hypervisor or operating system (OS) on each node. Virtual switches provide packet forwarding and networking capabilities to VCIs running on the node. In particular, each virtual switch uses hardware-based switching techniques to connect and transmit data between VCIs on a same node or different nodes.

A pod may be deployed on a single VM or a physical machine. The single VM or physical machine running a pod may be referred to as a node running the pod. From a network standpoint, containers within a pod share the same network namespace, meaning they share the same internet protocol (IP) address or IP addresses associated with the pod.

A network plugin, such as a container networking interface (CNI) plugin, may be used to create virtual network interface(s) usable by the pods for communicating on respective logical networks of the SDN infrastructure in a data center. In particular, the network plugin may be a runtime executable that configures a network interface, referred to as a pod interface, into a container network namespace. The network plugin is further configured to assign a network address (e.g., an IP address) to each created network interface (e.g., for each pod) and may also add routes relevant to the interface. Pods can communicate with each other using their respective IP addresses. For example, packets sent from a source pod to a destination pod may include a source IP address of the source pod and a destination IP address of the destination pod so that the packets are appropriately routed over a network from the source pod to the destination pod.

Communication between pods of a node may be accomplished through use of virtual switches implemented in nodes. Each virtual switch may include one or more virtual ports (Vports) that provide logical connection points between pods. For example, a pod interface of a first pod and a pod interface of a second pod may connect to Vport(s) provided by the virtual switch(es) of their respective nodes to allow for communication between the first and second pods. In this context, “connect to” refers to the capability of conveying network traffic, such as individual network packets or packet descriptors, pointers, or identifiers, between components to effectuate a virtual data path between software components.

Within a single cluster, the container orchestration platform supports network plugins for cluster networking, with such network plugins mainly focusing on pods and services within the single cluster. A service is an abstraction to expose an application running on a set of pods as a network service. While a client may make a request for the service, the request may be load balanced to different instances of the application (i.e., different pods). However, many Cloud providers operate multiple clusters in multiple regions or availability zones and run replicas of the same applications in several clusters.

### SUMMARY

One or more embodiments of a method for exchanging data between member clusters comprises receiving a data packet from a first pod in a first cluster of a cluster set through a pod interface, in which the data packet targets a second pod in a second cluster of the cluster set, determining a label identity for the first pod from a table of pods and label identities, adding the label identity for the first pod in a virtual network identifier field of the data packet header, and communicating the data packet from a first virtual switch to the second cluster through a tunnel interface and gateway node. The method may further comprise receiving the data packet in a second virtual switch of the second cluster through a second gateway node and second tunnel interface of the second cluster, extracting the label identity from the data packet, determining an ingress rule associated with the label identity, and controlling access to the second pod based on the rule.

Further embodiments include one or more non-transitory computer-readable storage media storing instructions that, when executed by one or more processors of a computer system, cause the computer system to perform the method set forth above, and a computer system including at least one processor and memory configured to carry out the method set forth above.

### BRIEF DESCRIPTION OF THE DRAWINGS

FIG. 1 illustrates a computing system in which embodiments described herein may be implemented.

FIG. 2 is a block diagram of an example container-based cluster for the computing system of FIG. 1, according to an example embodiment of the subject disclosure.

FIG. 3 illustrates a resource exchange pipeline to exchange network information between member clusters, according to an example embodiment of the subject disclosure.

FIG. 4 is a flow chart diagram of an example method of resource exchange between clusters, according to an example embodiment of the subject disclosure.

FIG. 5 is a flow chart diagram of a label identifier generation and distribution method, according to an example embodiment of the subject disclosure.

FIG. 6 depicts cross-cluster traffic and network policy enforcement, according to an embodiment of the subject disclosure.

FIG. 7 is a flow chart diagram of a method of cross-cluster communication, according to an embodiment of the subject disclosure.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

A network policy can be defined and enforced for a single cluster. A network policy is a set of rules that define how network traffic is allowed to flow and can be utilized to enforce security and control access to network resources. Traffic flow between pods and services within a cluster can be controlled in certain instances. For example, an administrator can define a network policy that specifies which pods can communicate with each other and which cannot. Further, a network policy can specify a set of ingress and egress rules that control traffic coming into a pod or service (e.g., ingress) and traffic leaving a pod or service (e.g., egress).

Techniques exist that enable applications to communicate with each other across clusters beyond the communication occurring in a single cluster, such that pods and services are accessible across clusters. A controller of each cluster may select one or more nodes (e.g., a plurality of nodes) as a gateway for the cluster. Each gateway in each cluster forms a tunnel with gateways of each other cluster. The tunnels may be formed using any suitable tunneling protocol (e.g., GENEVE, VXLAN, GRE, STT, L2TP). Accordingly, the gateways of each cluster can communicate with one another over the formed tunnels. Each node within each cluster is further configured to route traffic for a destination to another cluster, referred to as cross-cluster traffic, through the gateway of the cluster. A first gateway of the source node tunnels the traffic to a second gateway of the destination node. The second gateway of the destination node then routes the traffic to the destination node. A cluster set includes a plurality of member clusters, including pods or services that can communicate with each other through network tunnel connections between the gateways of the member clusters.

Techniques described herein pertain to extending network policy support beyond a single cluster to multiple cluster network traffic. A stretch or cross-cluster network policy (referred to herein as a network policy) can specify rules enforced regarding traffic flow between pods in different clusters. A network policy can be specified for different scopes, such as cluster and cluster set, in certain embodiments. A cluster scope can pertain to a traditional single cluster, and the cluster set scope can correspond to a group of clusters. In certain embodiments, a unique label identity can be determined for pods to match cross-cluster traffic accurately. The unique label identity can be generated from a normalized label string associated with a pod that combines pod labels and labels of respective namespaces in certain embodiments. Rules derived from a high-level network policy can be specified with respect to label identities. The rules and label identities can be distributed to cluster members through import from a cluster leader. Any packet flowing across cluster boundaries can carry the label identity of an initiating pod, such as in a virtual network identifier (VNI) field of the packet header. After a data packet reaches a target cluster, the label identity can be extracted and utilized to determine and enforce any rules associated with the label identity to permit or deny access to a destination pod.

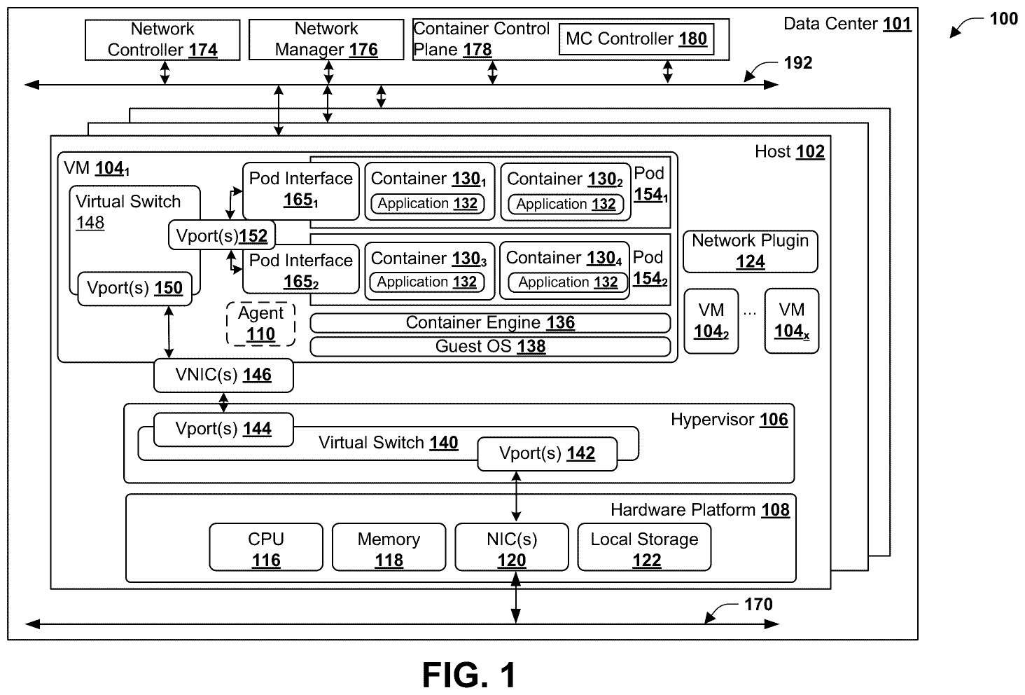

FIG. 1 depicts examples of physical and virtual network components in a networking environment 100 where embodiments of the subject disclosure may be implemented.

Networking environment 100 includes a data center 101. Data center 101 includes one or more hosts 102, a management network 192, a data network 170, a network controller 174, a network manager 176, and a container control plane 178 including a multi-cluster controller 180. Data network 170 and management network 192 may be implemented as separate physical networks or as separate virtual local area networks (VLANs) on the same physical network.

Host(s) 102 may be communicatively connected to data network 170 and management network 192. Data network 170 and management network 192 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 102 may be geographically co-located servers on the same rack or different racks in any arbitrary location in the data center. Host(s) 102 may be configured to provide a virtualization layer, also referred to as a hypervisor 106, that abstracts processor, memory, storage, and networking resources of a hardware platform into multiple VMs 104₁-104_{X} (collectively referred to herein as “VMs 104” and individually referred to herein as “VM 104”).

Host(s) 102 may be constructed on a server-grade hardware platform 108, such as an x86 architecture platform. Hardware platform 108 of a host 102 may include components of a computing device such as one or more processors (CPUs) 116, system memory 118, one or more network interfaces (e.g., physical network interface cards (PNICs) 120), storage 122, and other components (not shown). A CPU 116 is configured to execute instructions, for example, executable instructions that perform one or more operations described herein and that may be stored in the memory and storage system. The network interface(s) enable host 102 to communicate with other devices through a physical network, such as management network 192 and data network 170.

In certain aspects, hypervisor 106 implements one or more logical switches as a virtual switch 140. Any arbitrary set of VMs in a datacenter may be placed in communication across a logical Layer 2 (L2) overlay network by connecting them to a logical switch. A logical switch is an abstraction of a physical switch that is collectively implemented by a set of virtual switches on each host that has a VM connected to the logical switch. The virtual switch on each host operates as a managed edge switch implemented in software by a hypervisor on each host. Virtual switches provide packet forwarding and networking capabilities to VMs running on the host. In particular, each virtual switch uses hardware-based switching techniques to connect and transmit data between VMs on a same host or different hosts.

Virtual switch 140 may be attached to a default port group defined by a network manager that provides network connectivity to host 102 and VMs 104 on host 102. Port groups include subsets of virtual ports (“Vports”) of a virtual switch, each port group having a set of logical rules according to a policy configured for the port group. Each port group may comprise a set of Vports associated with one or more virtual switches on one or more hosts 102. Ports associated with a port group may be attached to a common VLAN according to the IEEE 802.1Q specification to isolate the broadcast domain.

A virtual switch 140 may be a virtual distributed switch (VDS). In this case, each host 102 may implement a separate virtual switch corresponding to the VDS, but the virtual switches 140 at each host 102 may be managed like a single virtual distributed switch (not shown) across the hosts 102.

Each of VMs 104 running on host 102 may include virtual interfaces, often referred to as virtual network interface cards (VNICs), such as VNICs 146, which are responsible for exchanging packets between VMs 104 and hypervisor 106. VNICs 146 can connect to Vports 144, provided by virtual switch 140. Virtual switch 140 also has Vport(s) 142 connected to PNIC(s) 120, allowing VMs 104 to communicate with virtual or physical computing devices outside of host 102 through data network 170 or management network 192.

Each VM 104 may also implement a virtual switch 148 for forwarding ingress packets to various entities running within the VM 104. Such virtual switch 148 may run on a guest OS 138 of the VM 104, instead of being implemented by a hypervisor, and may be programmed, for example, by agent 110 running on guest OS 138 of the VM 104. For example, the various entities running within each VM 104 may include pods 154 including containers 130. Depending on the embodiment, the virtual switch 148 may be configured with Open vSwitch (OVS), an open-source project to implement virtual switches to enable network automation while supporting standard management interfaces and protocols.

In particular, each VM 104 implements a virtual hardware platform that supports the installation of a guest OS 138, which is capable of executing one or more applications. Guest OS 138 may be a standard commodity operating system. Examples of a guest OS include Microsoft Windows®, Linux®, or the like.

Each VM 104 may include a container engine 136 installed therein and running as a guest application under the control of guest OS 138. Container engine 136 is a process that enables the deployment and management of virtual instances (referred to interchangeably herein as “containers”) by providing a layer of OS-level virtualization on guest OS 138 within VM 104 or an OS of host 102. Containers 130 are software instances that enable virtualization at the OS level. With containerization, the kernel of guest OS 138, or an OS of host 102 if the containers are directly deployed on the OS of host 102, is configured to provide multiple isolated user-space instances, referred to as containers. Containers 130 appear as unique servers from the standpoint of an end user that communicates with each of containers 130. However, from the standpoint of the OS on which the containers execute, the containers are user processes that are scheduled and dispatched by the OS.

Containers 130 encapsulate an application, such as application 132, as a single executable software package that bundles application code with all the related configuration files, libraries, and dependencies required to run. Application 132 may be any software program, such as a word processing program or a gaming server.

Data center 101 includes a container control plane 178. In certain aspects, the container control plane 178 may be a computer program that resides and executes in one or more central servers, which may reside inside or outside the data center 101, or alternatively, may run in one or more VMs 104 on one or more hosts 102. A user can deploy containers 130 through container control plane 178. Container control plane 178 is an orchestration control plane, such as Kubernetes®, to deploy and manage applications or services thereof on nodes, such as hosts 102 or VMs 104, of a node cluster, using containers 130. For example, Kubernetes may deploy containerized applications as containers 130 and a container control plane 178 on a cluster of nodes. The container control plane 178, for each cluster of nodes, manages the computation, storage, and memory resources to run containers 130. Further, the container control plane 178 may support the deployment and management of applications (or services) on the cluster using containers 130. In some cases, the container control plane 178 deploys applications as pods 154 of containers 130 running on hosts 102, either within VMs 104 or directly on an OS of the host 102. Other types of container-based clusters based on container technology, such as Docker® clusters, may also be considered. Though certain aspects are discussed with pods 154 running in a VM as a node, and container engine 136, agent 110, and virtual switch 148 running on guest OS 138 of VM 104, the techniques discussed herein are also applicable to pods 154 running directly on an OS of host 102 as a node. For example, host 102 may not include hypervisor 106, and may instead include a standard operating system. Further, agent 110 and container engine 136 may then run on the OS of host 102.

Further, MC (multi-cluster) controller 180 can be included within or otherwise communicatively coupled with the container control plane 178. The MC controller 180 is configured to connect multiple clusters together and support communications between pods running in different clusters. The MC controller can be configured to permit administrators to define network policies for traffic within a cluster. Moreover, the MC controller 180 can be configured to support an extended or stretch network policy, as described further herein, to allow administrators to specify cross-cluster network policies. In accordance with certain embodiments, the MC controller 180 can implement all portions of Antrea® or an Antrea® controller, where Antrea® is an open-source networking and security solution for clusters.

For packets to be forwarded to and received by pods 154 and their containers 130 running in a first VM 104₁, each of the pods 154 may be set up with a network interface, such as a pod interface 165. The pod interface 165 is associated with an IP address, such that the pod 154, and each container 130 within the pod 154, is addressable by the IP address. Accordingly, after each pod 154 is created, network plugin 124 is configured to set up networking for the newly created pod 154, enabling the new containers 130 of the pod 154 to send and receive traffic. As shown, pod interface 165₁ is configured for and attached to a pod 154₁. Other pod interfaces, such as pod interface 165₂, may be configured for and attached to different, existing pods 154.

The network plugin 124 may include a set of modules that execute on each node to provide networking and security functionality for the pods. In addition, an agent 110 may execute on each VM 104 (i) to configure the forwarding element and (ii) to handle troubleshooting requests. In addition, MC controller 180 may provide configuration data (e.g., forwarding information, network policy to be enforced) to agents 110, which use this configuration data to configure the forwarding elements (e.g., virtual switches) on their respective VMs 104, also referred to as nodes 104. Agent 110 may further be configured to forward node 104 or cluster information. In certain embodiments, VM 104 can correspond to one of a plurality of clusters in a cluster set that is either a member cluster or a leader cluster.

Data center 101 includes a network management plane and a network control plane. The management plane and control plane each may be implemented as single entities (e.g., applications running on a physical or virtual compute instance) or as distributed or clustered applications or components. In alternative aspects, a combined manager/controller application, server cluster, or distributed application may implement both management and control functions. In the embodiment shown, network manager 176 at least in part implements the network management plane, and network controller 174 and container control plane 178 in part implement the network control plane.

The network control plane is a component of software defined network (SDN) infrastructure and determines the logical overlay network topology and maintains information about network entities such as logical switches, logical routers, and endpoints. The logical topology information is translated by the control plane into physical network configuration data that is then communicated to network elements of host(s) 102. Network controller 174 generally represents a network control plane that implements software defined networks, e.g., logical overlay networks, within data center 101. Network controller 174 may be one of multiple network controllers executing on various hosts in the data center that together implement the functions of the network control plane in a distributed manner. Network controller 174 may be a computer program that resides and executes in a server in data center 101, external to data center 101 (e.g., such as in a public cloud) or, alternatively, network controller 174 may run as a virtual appliance (e.g., a VM) in one of hosts 102. Network controller 174 collects and distributes information about the network from and to endpoints in the network. Network controller 174 may communicate with hosts 102 via management network 192, such as through control plane protocols. In certain aspects, network controller 174 implements a central control plane (CCP) that interacts and cooperates with local control plane components, e.g., agents, running on hosts 102 in conjunction with hypervisors 106.

Network manager 176 is a computer program that executes in a server in networking environment 100, or alternatively, network manager 176 may run in a VM 104, e.g., in one of hosts 102. Network manager 176 communicates with host(s) 102 via management network 192. Network manager 176 may receive network configuration input from a user, such as an administrator, or an automated orchestration platform (not shown) and generate desired state data that specifies logical overlay network configurations. For example, a logical network configuration may define connections between VCIs and logical ports of logical switches. Network manager 176 is configured to receive inputs from an administrator or other entity, e.g., via a web interface or application programming interface (API), and carry out administrative tasks for data center 101, including centralized network management and providing an aggregated system view for a user.

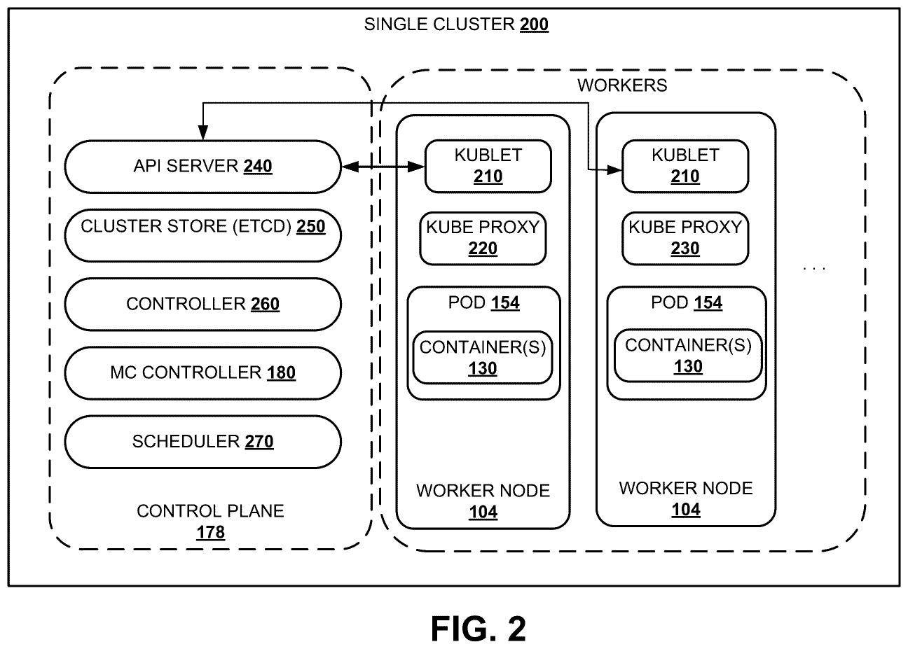

An example container-based cluster for running containerized workloads is illustrated in FIG. 2. It should be noted that the block diagram of FIG. 2 is a logical representation of a container-based cluster and does not show where the various components are implemented and run on physical systems. While the example container-based cluster shown in FIG. 2 is a Kubernetes (K8S) cluster 200, in other examples, the container-based cluster may be another type based on container technology, such as Docker® clusters.

When Kubernetes is used to deploy applications, a cluster, such as a single Kubernetes cluster 200, is formed from a combination of worker nodes 104 and a control plane 178. Though worker nodes 104 are shown as VMs 104 of FIG. 1, as discussed, the worker nodes 104 instead may be physical machines. In certain aspects, components of container control plane 178 run on VMs or physical machines. Worker nodes 104 are managed by control plane 178, which manages the computation, storage, and memory resources to run all worker nodes 104. Though pods 154 of containers 130 are shown running on cluster 200, the pods may not be considered part of the cluster infrastructure but rather as containerized workloads running on cluster 200.

Each worker node 104, or worker compute machine, includes a kubelet 210, which is an agent that ensures that one or more pods 154 run in the worker node 104 according to a defined specification for the pods, such as defined in a workload definition manifest. Each pod 154 may include one or more containers 130. The worker nodes 104 can execute various applications and software processes using container 130. Further, each worker node 104 includes a kube proxy 220. Kube proxy 220 is a Kubernetes network proxy that maintains network rules on worker nodes 104. These network rules allow network communication to pods 154 from network sessions inside or outside the Kubernetes cluster 200.

Control plane 178 includes components such as an application programming interface (API) server 240, a cluster store (etcd) 250, a controller 260, MC controller 180, and a scheduler 270. Components of the control plane 178 make global decisions about the Kubernetes cluster 200 (e.g., scheduling), as well as detect and respond to cluster events (e.g., starting up a new pod 154 when a workload deployment's replicas field is unsatisfied).

API server 240 operates as a gateway to Kubernetes cluster 200. As such, a command line interface, web user interface, users, or services communicate with Kubernetes cluster 200 through API server 240. One example of a Kubernetes API server 240 is kube-apiserver, which kube-apiserver is designed to scale horizontally—that is, this component scales by deploying more instances. Several instances of kube-apiserver may be run, and traffic may be balanced between those instances.

Cluster store (etcd) 250 is a data store, such as a consistent and highly-available key-value store, used as a backing store for data of the Kubernetes cluster 200. In accordance with certain embodiments, a network policy and/or rules derived from the network policy can be stored in cluster store 250. As discussed later herein, generated label identifiers can also be saved in cluster store 250.

Controller 260 is a control plane 178 component that runs and manages controller processes in Kubernetes cluster 200. For example, control plane 178 may have (e.g., four) control loops called controller processes that watch the state of cluster 200 and try to modify the current state of cluster 200 to match an intended state of cluster 200. In certain aspects, controller processes of controller 260 are configured to monitor external storage for changes to the state of cluster 200.

The MC controller 180 is configured to enable data flow between different clusters. Furthermore, the MC controller 180 can include functionality that allows administrators to define network policies that specify how traffic should be permitted or blocked between pods and services in the same cluster and across multiple clusters. In accordance with certain embodiments, The MC controller 180 check a label identity registry for all clusters and translate a high-level network policy (e.g., specified with label selectors) into data plane rules written with respect to label identities for enforcement. Though shown as separate, in certain aspects, MC controller 180 functionality may be part of controller 260.

Scheduler 270 is a control plane 178 component configured to allocate new pods 154 to worker nodes 104. Additionally, scheduler 270 may be configured to distribute resources and/or workloads across worker nodes 104. Resources may refer to processor resources, memory resources, networking resources, and/or the like. Scheduler 270 may watch worker nodes 104 for how well each worker node 104 handles its workload and match available resources to the worker nodes 104. Scheduler 270 may then schedule newly created containers 130 to one or more worker nodes 104.

In other words, control plane 178 manages and controls components of a cluster. Control plane 178 handles most, if not all, operations within the Kubernetes cluster 200, and its components define and control cluster configuration and state data. Control plane 178 configures and runs the deployment, management, and maintenance of the containerized applications.

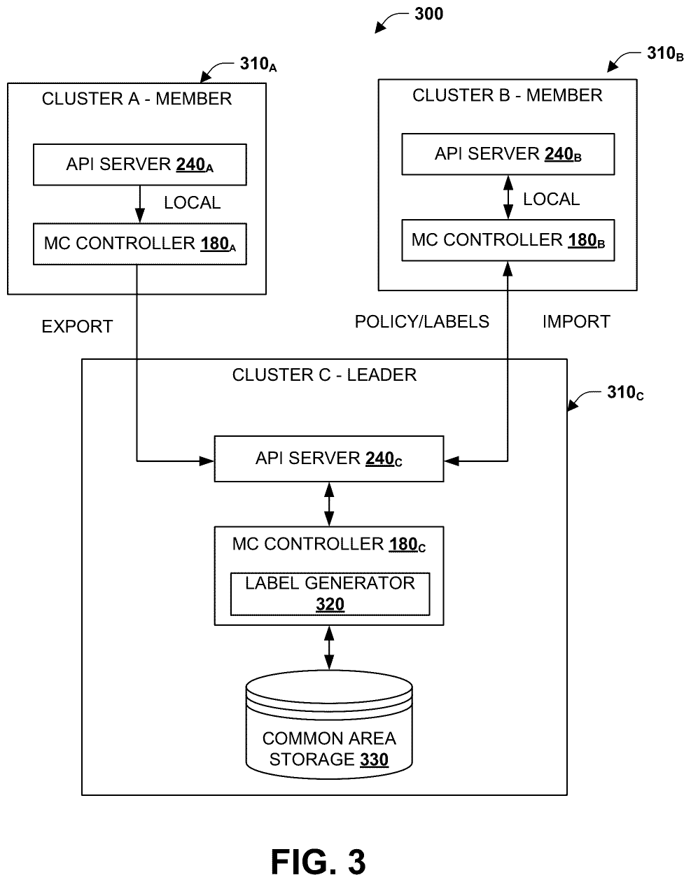

FIG. 3 depicts a resource exchange pipeline 300 in accordance with an example embodiment. Three clusters are depicted: cluster A 310_{A}, cluster B 310_{B}, and cluster C 310_{C} (collectively referred to as clusters 310). The clusters 310 can comprise a cluster set that is a group of clusters with a high degree of mutual trust that share services amongst themselves and work together as a single system.

An MC controller can be configured to synchronize services across clusters 310 and makes the services available for cross-cluster service discovery and connectivity. In accordance with certain embodiments, MC controllers can be decentralized and run in each cluster of a cluster set with two different roles: leader cluster and member clusters. As illustrated, cluster A 310_{A} and cluster B 310_{B} are member clusters, and cluster C 310_{C} is the leader cluster. Further, each of the clusters 310 includes a respective API server 240_{A}, 240_{B}, and 240_{C} and MC controller 180_{A}, 180_{B}, and 180_{C}.

The leader cluster 310_{C} is configured to act as the control plane for the entire cluster set to facilitate the distribution of resource exporting and importing among clusters. The leader cluster 310_{C} (which can also be a member cluster) can also enable initially declaring a cluster set and generating secret tokens to be distributed to potential member clusters. With the generated tokens, clusters can join the cluster set by securely connecting to the leader cluster API server 240_{C}.

Resources can be exchanged by members of the cluster set through a resource exchange pipeline. In accordance with certain embodiments, two custom resources can traverse the resource pipeline: export and import. Export encapsulates information regarding a resource, such as type and specification of a resource being exported. Import aggregates exported resources from different clusters and computes a final payload to be imported into each cluster. To implement a resource exchange pipeline, a common area is introduced where resources declared for export can be accessed by all members by resource imports.

The leader cluster 310_{C} serves as the common area in the cluster set. Member clusters can monitor import events in the common area storage 330 through the API server 240_{C} in the leader cluster 310_{C} and reconcile to in-cluster resources, such as service and network policy, to match the desired state specified by a resource import. The MC controller running in each member cluster can also be responsible for creating resource exports for any resources marked for export.

Multiple resources can be enclosed into resource exports and imports for specific purposes, including service and endpoints, cluster information, cluster network policy, and label identity. As per network policy, in-cluster network policies can be replicated to peer clusters when an administrator creates a resource export including a desired network policy. A network policy can be created in the leader cluster 310_{C}, which can be distributed to member clusters (or a subset based on filter criteria). The imported policy can then be applied to individual clusters as if the policy was created in-cluster locally. The network policy can be created declaratively, making it effortless for an administrator of a multi-cluster deployment to define a consistent security posture across all clusters without additional tooling. Declarative policy specification is especially useful for ensuring namespaces are isolated across all clusters in a cluster set by default. Concerning label identity, a custom resource can exist for identifying unique pod labels. Each cluster's MC controller can export their own label identities for use in cross-cluster traffic policy enforcement.

In addition to policy replication, the MC controllers can enforce network policies on cross-cluster traffic. In certain embodiments, network policy features enable restriction of pod egress traffic to backends of a multi-cluster service regardless of whether they are on the same cluster as the source pod or a different cluster. However, enforcing policy on ingress traffic is a problem, as cross-cluster packets are often subject to source network address translation (SNAT), which modifies the source internet protocol (IP) addresses of hosts or nodes, making it difficult to apply IP-based source matching. Further, even if the original IP address is not changed, many workload pod IP addresses and labels must be synchronized among the entire cluster set to match cross-cluster label selectors. This synchronization process can significantly impact network bandwidth and the overall performance of the solution, especially given the ephemeral nature of pods.

These challenges and performance issues are overcome by using a label identity to match cross-cluster traffic accurately. In certain embodiments, member clusters can generate a normalized string for all pods, such as by combining pod labels and labels of respective namespaces. The normalized string is exported to the leader cluster 310_{C} through the resource exchange pipeline. Label generator 320 is configured to generate a unique label identity for each unique normalized label string in the cluster set. All member clusters can then import all label identities to ensure they are synchronized across the cluster set. The label identity can be included with any data packet flowing in the cluster set to enable precise ingress cross-cluster packet matching.

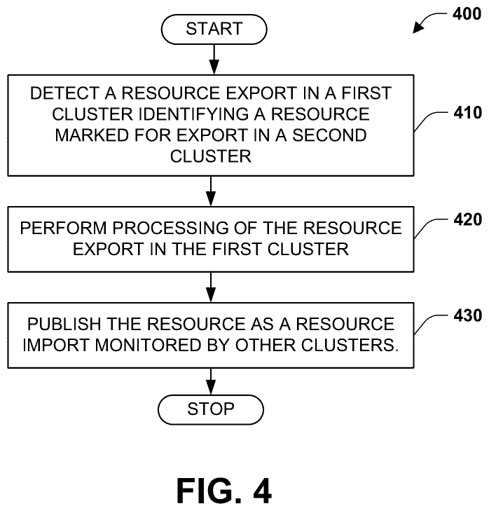

FIG. 4 depicts an example method 400 of resource exchange between clusters. In block 410, a resource export is detected from a cluster for a resource marked for export. In FIG. 3, cluster A 310_{A}, a local resource can be marked for export by an administrator of cluster A 310_{A} through the API server 240_{A}. By marking a local resource for export, the administrator provides permission for the local resource to be transmitted outside the cluster A 310_{A} to another cluster. The MC controller 180_{A} can identify the resource marked for export and trigger export of the local resource to the leader cluster C 310_{C}. In block 420, method 400 performs processing of the resource export. The processing can involve resource-particular computations and filtering. In certain embodiments, the processing can comprise generating unique labels from exported label strings by the label generator 320 of FIG. 3. In block 430, method 400 publishes or otherwise makes the resource available for import by other clusters. For instance, cluster B 310_{B} can monitor the common area of leader cluster C for resources and import the resources as local resources to cluster B 310_{B} through the MC controller 180_{B} and API server 240_{B}. In accordance with one particular embodiment, a network policy that controls intra-cluster traffic, inter-cluster traffic, or both can be specified by an administrator of the leader cluster C 310_{C} and imported into cluster B 310_{B} (as well as cluster A 310_{A}) as a local network policy for enforcement.

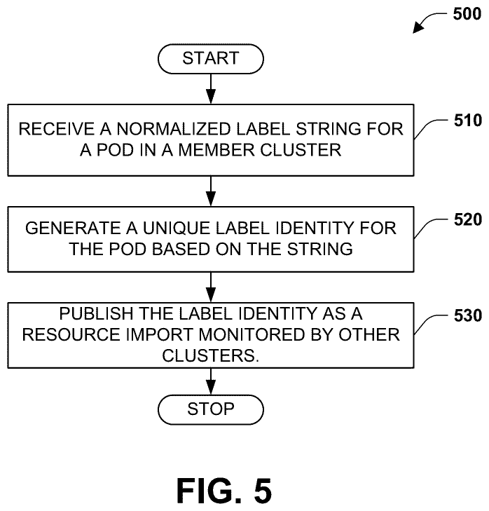

FIG. 5 is a flow chart diagram of an example label identifier generation and distribution method 500. Under certain embodiments, the method 500 can be implemented by the label generator 320 in conjunction with MC controller 180_{C} and API server 240_{C} of leader cluster C 310_{C} of FIG. 3. In block 510, the method 500 receives a normalized label string for a pod from a member cluster that combines pod labels and respective namespaces.

In block 520, method 500 generates a unique label identity for the pod based on the received string. In accordance with one embodiment, the label identity can be calculated as follows: “‘ns’+labels.FormatLabels (podNamespaceLabels)+‘&pod’+labels.FormatLabels (podLa bels)” wherein “ns” and “&pod” are text that serves to delineate namespace and pod portions of the label identity and “FormatLabels” is a function that determines and returns namespace and pod labels. An example label identity may appear as follows: “ns: kubernetes.io/metadata.name=us=west-, purpose-test&pod: app=client.” In certain embodiments, namespace labels are included in situations where policies utilize namespace selectors in addition to pod selectors to select ingress peers across clusters.

In block 530, method 500 publishes the label identity for import by other clusters. To enable replication of label identities in a cluster set so that each cluster knows what label identities match a policy, mechanisms to export and import these identities can be employed. In accordance with certain embodiments, custom resource definitions (CRD) are specified for exporting and importing label identities as follows. A reconciler may also be added to the MC controller to monitor pod and namespace create, read, update, and delete (CRUD) events and update all label identities in a cluster into a resource export object of type “LabelIdentities.”

/ / ResourceExportSpec defines the desired state of ResourceExport.
type ResourceExportSpec struct {
/ / ClusterID specifies the member cluster this resource exported
from.
ClusterID string ‘json: “clusterID, omitempty”’
/ / Name of exported resource.
Name string ‘json: “name, omitempty”’
/ / Namespace of exported resource.
Namespace string ‘json: “namespace, omitempty”’
/ / Kind of exported resource.
Kind string ‘json: “kind, omitempty”’
/ / If exported resource is Service.
Service *ServiceExport ‘json: “service, omitempty”’
. . . . . . .
/ / If exported resource is AntreaClusterNetworkPolicy.
ClusterNetworkPolicy *vlalpha1.ClusterNetworkPolicySpec
`json: “clusternetworkpolicy, omitempty”
+ / / If exported resource is LabelIdentities of a cluster.
+ LabelIdentities *LabelIdentityExport
‘json: “labelIdentities, omitempty”’
/ / If exported resource kind is unknown.
Raw *RawResourceExport ‘json: “raw, omitempty”’
}
type LabelIdentityExport struct {
NormalizedLabels [ ]string ‘json: “normalizedLabels, omitempty”’
}

In certain embodiments, another reconciler can be added to the leader cluster C 310_{C}, which monitors export of type “LabelIdentities” from all member clusters and assigns an identifier for each unique label identity in the cluster set. Certain embodiments can include creating a custom resource definition (CRD) object of type “LabelIdentityImport” for each label identity and identifier pair. The label generator 320 in the leader cluster C 310_{C} can translate “n” “ResourceImport” objects into “k” (number of unique label identities) “LabelIdentityImport” objects specified below:

| | |
|---|---|
| type | LabelIdentityImport struct { |
| | metav1.TypeMeta ‘json: “, inline”’ |
| | metav1.ObjectMeta ‘json: “metadata, omitempty”’ |
| | Spec LabelIdentityImportSpec ‘json: “spec, omitempty”’ |

}

| | |
|---|---|
| type | LabelIdentityImportSpec struct { |
| | Label string ‘json: “label, omitempty”’ |
| | ID uint32 ‘json: “id, omitempty” |

}

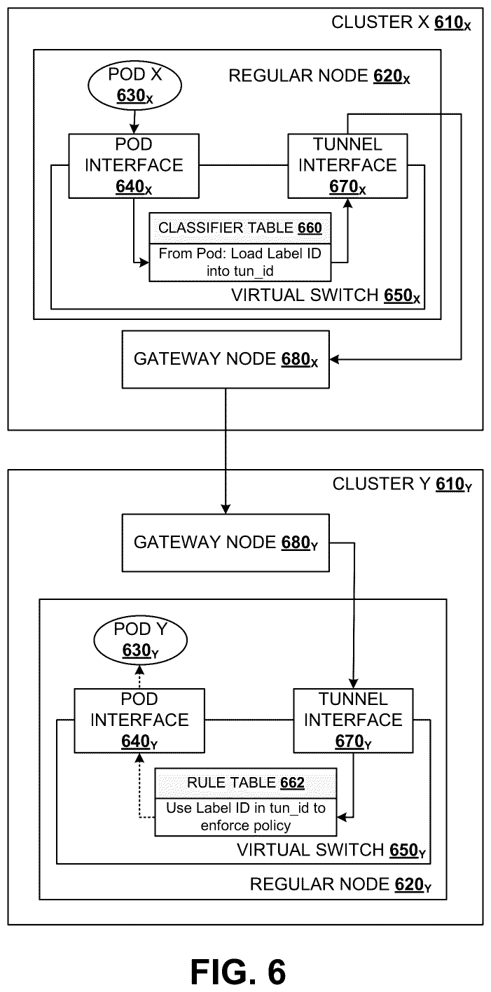

FIG. 6 depicts cross-cluster traffic and network policy enforcement. There are two clusters: cluster X 610_{X} and cluster Y 610_{Y}. Each cluster includes a corresponding regular node (regular node 620_{X} and regular node 620_{Y}) and gateway node (gateway node 680_{X} and gateway node 680_{Y}). The regular nodes 620_{X} and 620_{Y} perform computation tasks and can communicate with other nodes in a cluster. The gateway nodes 680_{X} and 680_{Y} enable communication outside the cluster by serving as a bridge between an internal cluster and another cluster. The regular nodes 620_{X} and 620_{Y} also include respective virtual switches 650_{X} and 650_{Y}, which enable network communication between pods within a node and between a pod and external pods or services. Regular node 620_{X} includes pod X 630_{X} that interfaces with the virtual switch 650_{X} by way of a pod interface 640_{X}. The virtual switch 650_{X} includes a classifier table 660 to look up a label identifier for a target of a cross-cluster communication. The tunnel interface 670_{X} can be a virtual network interface that creates secure connections between two or more nodes. The gateway node 680_{X} enables cross-cluster communication. The gateway node 680_{Y} is configured to receive communications from other gateways and pass the communication to the tunnel interface 670_{Y} and the virtual switch 650_{Y}. The virtual switch can include a rule table 662 associated with or more network policies. A rule can be looked up in rule table 662 with the label identity associated with the source of the communication. The rule can specify that the communication be blocked or denied. Alternatively, the rule can indicate that the communication is allowed or permitted, which can then result in passing the communication to pod Y 630_{Y} through the pod interface 640_{Y} if pod Y 630_{Y} is the communication destination.

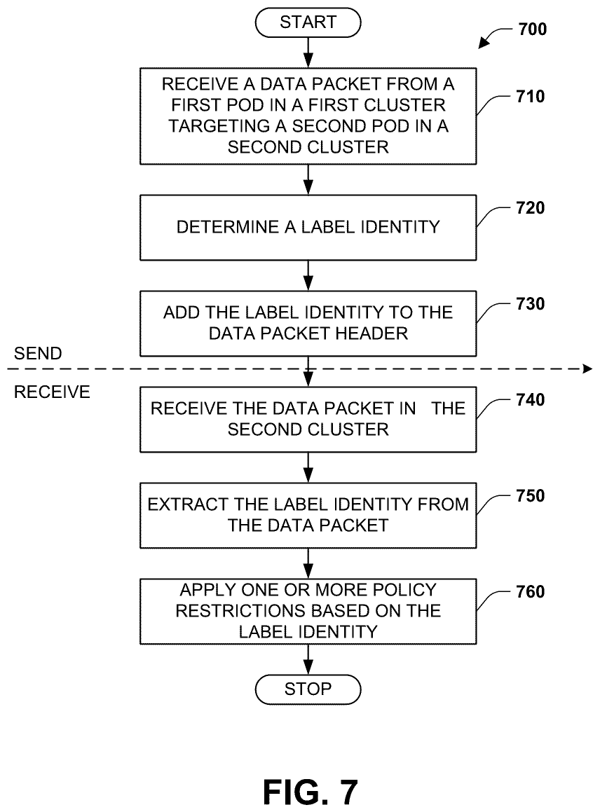

FIG. 7 is a flow chart diagram of an example method 700 of cross-cluster communication. Method 700 can be employed in conjunction with components associated with cross-cluster communication in FIG. 6.

In block 710, method 700 receives a data packet from a first pod in a first cluster targeting a second pod in a second cluster. In FIG. 6, pod X 630_{X} in cluster X 610_{X} can send a data packet to pod Y 630_{Y} in cluster Y 610_{Y}. In one embodiment, the virtual switch 650_{X} can receive the data packet from the pod X 630_{X} through the pod interface 640_{X}.

In block 720, method 700 determines a label identity. In accordance with certain embodiments, the classifier table 660 of FIG. 6 can be utilized to look up a label identifier for the pod X 630X, for instance, based on pod labels or namespace.

In block 730, method 700 adds the label identity to the data packet header (e.g., tun_id). Any packet flowing between cluster boundaries can carry the label identifier of the initiating pod in the virtual network identifier (VNI) field of its header in some embodiments. The data packet with the label identity can be transmitted through the tunnel interface 670_{X} and gateway node 680_{X} to cluster Y 610_{Y} in FIG. 6.

In block 740, method 700 receives the data packet in the second cluster. For instance, the data packet can be received by gateway node 680_{Y}. Subsequently, the data packet can be received by the regular node 620_{Y} and the virtual switch 650_{Y} through the tunnel interface 670_{Y} in FIG. 6.

In block 750, method 700 extracts the label identity from the data packet. In certain embodiments, method 700 can extract the label identity from a VNI field in a header of the data packet.

In block 760, method 700 identifies and applies zero or more policy rules based on the label identity. A network policy can be specified with respect to the label identity. Accordingly, in certain embodiments, zero or more rules can be identified from rule table 662 in FIG. 6 with a lookup of the label identity. If a rule blocks access to pod Y 630_{Y} based on the label identity of the sending pod X 630_{X}, method 700 can terminate. Alternatively, if there is no rule or a rule that provides permission to communicate with pod Y 630_{Y}, then the data packet can be routed to pod Y 630_{Y} through the pod interface 640_{Y}, and method 700 can subsequently terminate.

What follows is an example of a multi-cluster network policy including an ingress rule that may be specified by a cluster set administrator.

```
apiVersion: crd.antrea.io/vlalpha1
kind: AntreaNetworkPolicy
metadata:
  name: db-svc-allow-ingress-from-client-only
  namespace: prod-us-west
spec:
  appliedTo:
  - podSelector:
    matchLabels:
      app: db
  priority: 1
  tier: application
  ingress:
  - action: Allow
  from:
  - scope: clusterSet
  podSelector:
    matchLabels:
    app: client
  - action: Deny
```

The ingress rule specifies pods that are allowed to communicate with pods with an application label of “db.” All pods in the namespace “product-us-west” from all clusters in the cluster set are selected, and if the namespace exists in that cluster whose labels match an application of “client,” the pods that match the label are allowed to communicate with the application “db.” All other pods are not permitted to communicate with the application “db.” Here, the scope is set as cluster set as opposed to cluster to indicate that the policy applies to multiple clusters in a cluster set and not a single cluster.

Although not present in the example, the network policy can include, the policy can include additional rules that have the same destination and matching condition as original rules but use an unknown label, in accordance with certain embodiments. A label may be unknown due to a change pod label update or addition of a new pod. The network policy can control data packets with a normal label identifier (e.g., same format, similarity match that satisfies a threshold) and drop packets with unknown label identifiers. In this way, a preexisting pod need not lose connection awaiting a label identity update.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities. Usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer-readable media. The term computer-readable medium refers to any data storage device that can store data that can thereafter be input to a computer system-computer readable media may be based on any existing or subsequently developed technology for embodying computer programs in a manner that enables them to be read by a computer. Examples of a computer-readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements or steps do not imply any particular order of operation, unless explicitly stated in the claims.

In accordance with the various embodiments, virtualization systems may be implemented as hosted embodiments, non-hosted embodiments, or embodiments that tend to blur distinctions between the two are all envisioned. Furthermore, various virtualization operations may be wholly or partially implemented in hardware. For example, a hardware implementation may employ a look-up table to modify storage access requests to secure non-disk data.

Certain embodiments, as described above, involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the preceding embodiments, virtual machines are used as an example for the contexts, and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers”. OS-less containers implement operating system-level virtualization, wherein an abstraction layer is provided on top of the kernel of an operating system on a host computer. The abstraction layer supports multiple OS-less containers, each including an application and its dependencies. Each OS-less container runs as an isolated process in user space on the host operating system and shares the kernel with other containers. The OS-less container relies on the kernel's functionality to make use of resource isolation (CPU, memory, block I/O, network) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory, and I/O. The term “virtualized computing instance,” as used herein, is meant to encompass both VMs and OS-less containers.

Many variations, modifications, additions, and improvements are possible, regardless of the degree of virtualization. The virtualization software can therefore include components of a host, console, or guest operating system that performs virtualization functions. Plural instances may be provided for components, operations, or structures described herein as a single instance. Boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of exchanging data between clusters:
receiving a data packet from a first pod in a first cluster of a cluster set through a pod interface, wherein the data packet targets a second pod in a second cluster of the cluster set;
determining a label identity for the first pod from a table of pods and label identities;
adding the label identity for the first pod in a header of the data packet; and
communicating the data packet from the first cluster to the second cluster through a gateway node.

2. The method of claim 1, further comprising:
receiving the data packet at the second cluster;
extracting the label identity from the data packet;
determining an ingress rule associated with the label identity; and
applying the ingress rule to the data packet.

3. The method of claim 2, further comprising importing a network policy from a leader cluster in the cluster set, the network policy including the ingress rule.

4. The method of claim 3, wherein the network policy is specified with a cluster set scope

5. The method of claim 2, wherein applying the ingress rule comprises dropping the data packet.

6. The method of claim 2, wherein applying the ingress rule comprises forwarding the data packet to the second pod.

7. The method of claim 1, wherein adding the label identity to the header comprises adding the label identity to a virtual network identifier (VNI) field of the header.

8. A system, comprising:
one or processors coupled to one or more memories that store instructions, that when executed by the one or more processors, cause the system to:
receive a data packet from a first pod in a first cluster of a cluster set through a pod interface, wherein the data packet targets a second pod in a second cluster of the cluster set;
determine a label identity for the first pod from a table of pods and label identities;
add the label identity for the first pod in a header of the data packet; and
communicate the data packet from the first cluster to the second cluster through a gateway node.

9. The system of claim 8, wherein the instructions, when executed by the one or more processors, further cause the system to:
receive the data packet at the second cluster;
extract the label identity from the data packet;
determine an ingress rule associated with the label identity; and
apply the ingress rule to the data packet.

10. The system of claim 9, wherein the instructions, when executed by the one or more processors, further cause the system to import a network policy, including the ingress rule, from a leader cluster in the cluster set.

11. The system of claim 10, wherein the network policy specifies a cluster set scope for cross-cluster control.

12. The system of claim 9, wherein applying the ingress rule causes the system to drop the data.

13. The system of claim 9, wherein applying the ingress rule causes the system to forward the data packet to the second pod.

14. The system of claim 8, wherein the instructions, when executed by the one or more processors, further cause the system to generate the label identity based on a normalized string received from the first cluster.

15. One or more non-transitory computer-readable media comprising instructions that, when executed by one or more processors of a computing system, cause the computing system to perform a method for exchanging data between clusters, the method comprising:
receiving a data packet from a first pod in a first cluster of a cluster set through a pod interface, wherein the data packet targets a second pod in a second cluster of the cluster set;
determining a label identity for the first pod from a table of pods and label identities;
adding the label identity for the first pod in a header of the data packet; and
communicating the data packet from the first cluster to the second cluster through a gateway node.

16. The one or more non-transitory computer-readable media of claim 15, the method further comprising:
receiving the data packet in a second virtual switch of the second cluster through a second gateway node and second tunnel interface of the second cluster;
extracting the label identity from the data packet;
determining an ingress rule associated with the label identity; and
controlling access to the second pod based on the ingress rule.

17. The one or more non-transitory computer-readable media of claim 16, the method further comprising importing a network policy, including the ingress rule, from a leader cluster in the cluster set.

18. The one or more non-transitory computer-readable media of claim 17, wherein the network policy specifies a cluster set scope for one or more cross-cluster communication rules.

19. The one or more non-transitory computer-readable media of claim 17, wherein controlling access further comprises dropping the data packet in accordance with the ingress rule.

20. The one or more non-transitory computer-readable media of claim 15, the method further comprising generating the label identity based on a normalized string received from the first cluster.
